(19) United States
(12) Patent Application Publication
(10) Pub. No.: US 2023/0171809 A1
(43) Pub. Date: Jun. 1, 2023

(54) PRIORITIZED EARLY CSI REPORTING

(71) Applicant: Telefonaktiebolaget LM Ericsson (publ), Stockholm (SE)

(72) Inventors: Zhipeng LIN, Nanjing, Jiangsu (CN); Jingya LI, Göteborg (SE); Henrik SAHLIN, Molnlycke (SE)

(73) Assignee: Telefonaktiebolaget LM Ericsson (publ), Stockholm (SE)

(21) Appl. No.: 17/921,883

(22) PCT Filed: Apr. 28, 2021
(86) PCT No.: PCT/EP2021/061130

§ 371 Date: Oct. 27, 2022

(30) Foreign Application Priority Data
Apr. 29, 2020 (CN) PCT/CN2020/087791

(51) Int. Cl. H04W 74/08; H04B 7/06

(52) U.S. Cl. CPC H04W 74/0833; H04W 74/0875; H04B 7/0626

(57) ABSTRACT

Methods and devices for early CSI reporting by high priority devices, such as for mission critical services. Early reporting can be configured or otherwise indicated by a node for UEs having a particular status, access identity, and/or access category. Reported feedback can include a transmission rank indicator (RI), a precoder matrix indicator (PMI), and a channel quality indicator (CQI) for a codeword.

### TECHNICAL FIELD

Embodiments herein relate generally to nodes and other devices in a communication system, a method performed by a node, and a method performed by device. More particularly, embodiments herein relate to prioritized early channel state information (CSI) reporting for mission critical services and devices.

### BACKGROUND

First responders, such as fire-fighters, the police, and emergency medical service providers, often require fast, reliable and secure communications in various mission critical (MC) situations. For instance, in disaster and emergency situations, first responders as well as other essential public safety service providers rely on the availability of MC network services to coordinate their operations. Therefore, cellular coverage can be essential. Compared to other use cases (e.g., enhanced Mobile Broadband (eMBB)), the coverage requirements for public safety communications are typically more strict (e.g., 99% of the population, 99% of landmass, 99.5% outdoor, 95% indoor, etc.).

Before data transmission and reception, MC devices (e.g., user equipment (UEs)) must perform a random access procedure to establish a radio resource control (RRC) connection to the network. However, in existing systems, a mechanism is not available for adapting the random-access procedure to ensure fast and reliable network connection establishment for MC devices. In addition, among the downlink physical channels, physical downlink share channel (PDSCH) carrying Msg2 or MsgB or Msg4 could be the weakest one that limits network coverage. Therefore, it may be important to prioritize and improve the robustness of the Msg2 or MsgB or Msg4 transmission for MC devices.

Thus, there remains a need for effective early CSI reporting. For instance, currently, there are no mechanisms for prioritizing an early CSI report for improving the robustness of the Msg2/MsgB/Msg4 transmission for high priority UEs in initial access.

### SUMMARY

According to embodiments, a method is provided in which a network supports prioritized, fast CSI reporting from devices (e.g., UEs) configured with high priority services, such as for mission critical applications. The method may comprise, for instance, one or more of the following: (i) enabling early CSI reports via a CSI request indication in a message (e.g., a random access response (RAR), which can be RAR in a 4-step random access (RA), a fallback RAR in a 2-step RA, or a success RAR in a 2-step RA); (ii) configuring the system such that CSI reporting is always expected for high priority UEs; and (iii) enabling (or disabling) early CSI reporting for UEs with different priorities (e.g., access identity and/or access category) by broadcasted system information.

According to embodiments, a method is provided (e.g., in a gNB) that comprises: determining that a first device (e.g., a UE) has a high priority status (e.g., is indicated for prioritized early CSI reporting); and sending a channel state information CSI reporting indication in a message (e.g., in a random access response (RAR) message) to the first device based at least in part on the status determination, wherein the message is configured to trigger early CSI reporting from the first device.

According to embodiments, a method is provided (e.g., in a gNB) that comprises broadcasting system information, and receiving an early CSI report (e.g., CSI feedback message) from a first device (e.g., UE).

According to embodiments, a method is provided (e.g., in a UE) that comprises receiving a channel state information (CSI) reporting indication in a message (e.g., a random access response message) from a node, and sending an early CSI feedback message (e.g., CSI report) to the node, wherein the device has a high priority status.

According to embodiments, a method is provided (e.g., in a UE) that comprises: receiving broadcasting system information from a node (e.g., a gNB); determining that the device is enabled for early CSI reporting, wherein the determining is based at least in part on a high priority status of the device; and sending an early CSI report (e.g., CSI feedback message) to the node.

According to embodiments, a method in a device is provided, comprising: receiving a message from a node that indicates early CSI reporting; and sending a CSI feedback message to the node before completion of a radio resource control, RRC, connection or as part of a random access procedure, wherein the device has a high priority status.

According to embodiments, a method in a device is provided, comprising: receiving broadcast system information from a node indicating early CSI reporting for high priority devices; determining that the device is enabled for early CSI reporting based at least in part on the broadcasted system information and a status of the device; and sending an early CSI report to the node.

According to embodiments, a method in a node is provided, comprising: determining that a first device has a high priority status; and sending a message to the first device based at least in part on the status determination, wherein the message is configured to trigger CSI reporting from the first device before completion of a radio resource control, RRC, connection or as part of a random access procedure.

According to embodiments, a method in a node is provided, comprising: broadcasting system information indicating early CSI reporting for high priority devices; and receiving an early CSI report from a first device having a high priority status, wherein the early CSI report is received before completion of a radio resource control, RRC, connection or as part of a random access procedure with the first device.

According to embodiments, a network node (e.g., gNB) or device (e.g., UE) is provided that is configured to perform one or more of the disclosed methods. The node or device may comprise, for instance, a processor and a memory.

In some embodiments, a network node enables early CSI reporting based on the UE or service priority, so that it can provide proper and fast link adaptation to higher priority UEs in initial access.

According to embodiments, a computer program comprising computer program code stored on a non-transitory computer readable medium is provided, which, when run on a node or other device, causes the device to perform one or more of the disclosed methods.

In certain aspects, one or more of the proposed solutions can enable a network node to trigger early CSI feedback from MC UEs in a RACH procedure, so that a proper fast link adaptation can be applied to higher priority UEs.

### BRIEF DESCRIPTION OF THE DRAWINGS

The accompanying drawings, which are incorporated herein and form part of the specification, illustrate various embodiments.

FIG. 1A is a signal flow diagram illustrating a four-step random access procedure for initial access. FIG. 1B illustrates the mapping between SSB and random access preambles. FIG. 1C is a signal flow diagram illustrating a two-step random access procedure for initial access. FIG. 1D illustrates an example of resource element allocation for a 12-port CSI-RS resource in New Radio (NR).

FIG. 2 illustrates a system according to embodiments.

FIG. 3 is a schematic block diagram of a network node according to some embodiments.

FIG. 4 is a schematic block diagram of a device according to some embodiments.

FIGS. 5A and 5B are flow charts illustrating a process according to embodiments.

FIGS. 6A and 6B are flow charts illustrating a process according to embodiments.

FIG. 7 illustrates a CSI request in a success RAR in a 2-step random access procedure, according to embodiments.

FIG. 8 is a flow chart illustrating a process according to embodiments.

FIG. 9 is a flow chart illustrating a process according to embodiments.

FIG. 10 is a flow chart illustrating a process according to embodiments.

FIG. 11 is a flow chart illustrating a process according to embodiments.

### DETAILED DESCRIPTION

For New Radio (NR) initial access, before a UE can properly communicate within a network, it typically must carry out a cell search to find, synchronize and identify a cell. Then, it can acquire basic system information and perform random access procedures to establish a connection to the cell. According to embodiments, early CSI reporting can be enabled and used, for instance, before completion of a radio resource control, RRC, connection or as part of the random access procedure itself.

In NR, the combination of synchronization signals (SS) and physical broadcast channel (PBCH) is referred to as a SS/PBCH block (SSB). Similar to LTE, a pair of SS, primary synchronization signal (PSS) and secondary synchronization signal (SSS), is periodically transmitted on downlink from each cell to allow a UE to initially access to the network. By detecting SS, a UE can obtain the physical cell identity, achieve downlink synchronization in both time and frequency, and acquire the timing for the physical broadcast channel (PBCH). PBCH carries the master information block (MIB), which contains minimum system information that a UE needs to acquire system information block 1 (SIB1). SIB1 carries the remaining minimum system information that is needed for a UE to be able to perform a subsequent random access procedure. Two types of random access procedures in NR are the 4-step and 2-step procedures. Aspects of this disclosure use the 4-step and 2-step random access procedures as examples (e.g., Msg2, Msg3, MsgA, and MsgB); however, embodiments can be applie in connection with other random access procedures or responses, and for prioritization of other messaging for mission critical communications or other prioritized devices.

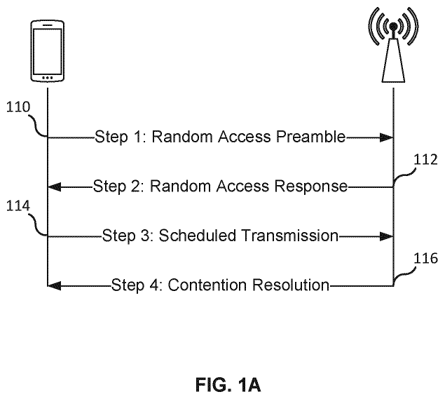

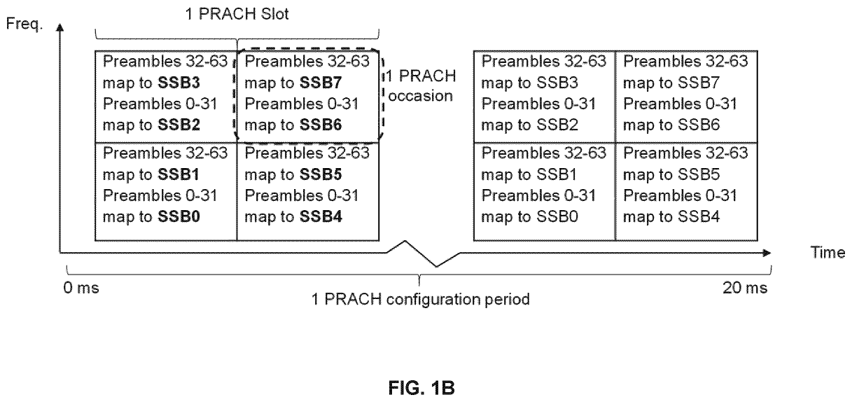

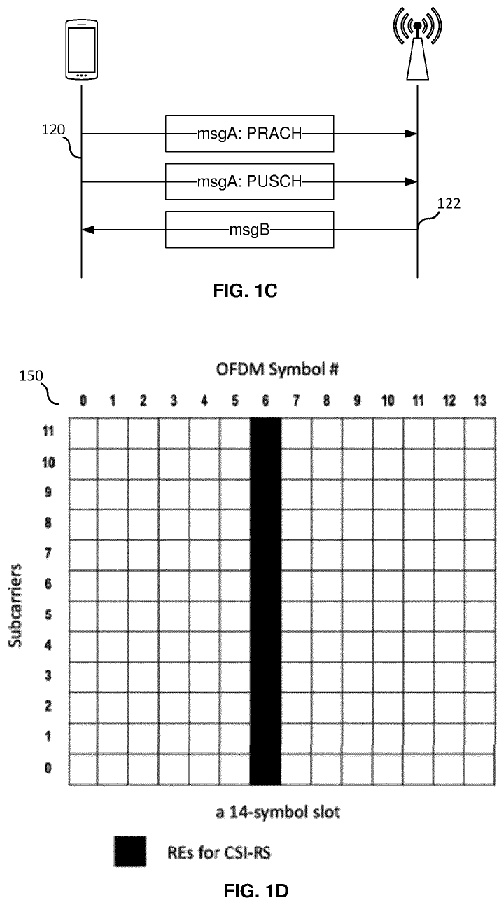

An example of a 4-step random access procedure is illustrated in FIG. 1A. For initial access, a UE initiates the random access procedure by transmitting 110 in the uplink (UL) a random access preamble (Msg1 in this example) on a physical random access channel (PRACH). After detecting the Msg1, the node (e.g., gNB) will respond 112 by transmitting in the downlink (DL) a random access response (RAR) on a physical downlink share channel (PDSCH) (Msg2 in this example). In the third step 114, after successfully decoding Msg2, the UE continues the procedure by transmitting in UL a PUSCH (Msg3) for terminal identification and RRC connection establishment request. In the last step 116 of the procedure, the gNB transmits in DL a PDSCH (Msg4) for contention resolution. In some embodiments, an early CSI report is provided with Msg3.

A UE can initiate a random-access procedure by transmitting in UL a random-access preamble (Msg 1) on a physical random-access channel. In NR, the time and frequency resource on which a random-access preamble (Msg 1) is transmitted is defined as a PRACH occasion. Presently, there are up to 64 sequences that can be used as random-access preambles per PRACH occasion in each cell. Each SSB index is typically associated with a set of valid PRACH occasions and a set of preambles. FIG. 1B shows an example of the mapping between SSBs and preambles in different PRACH occasion. In this example, the PRACH format can be A3 (2 TD occs./slot), with a PRACH config. period of 20 ms, 2 PRACH slots per config. period, PRACH FDMed of 2, and the number of SBBs as 8. Additionally, the #SSB-perPRACH-Occasion can be 2, with the totalNumberofRA-preambles at 64.

After detecting a random-access preamble (Msg1), the gNB will respond by transmitting in DL a random-access response (RAR) on a PDSCH (Msg2). The PDSCH carrying RAR is scheduled by a physical downlink control channel (PDCCH) carrying DCI format 1_0 with CRC scrambled by a RA-RNTI, in this example. The RA-RNTI is associated with the PRACH occasion in which the preamble is detected. If multiple preambles from multiple UEs are detected on the same time-frequency PRACH occasion, then, the Msg2 carried on a PDSCH will consist of multiple RARs. The content of RAR for each detected random-access preamble includes a Random-access preamble ID (RAPID), which indicates the received preamble index. Typically, a UE derives its corresponding RA-RNTI based on the PRACH occasion selected for its preamble transmission. After transmitting a random-access preamble, the UE will start monitoring the PDCCH candidates scrambled by the corresponding RA-RNTI within a time window, which is provided by the parameter ra-ResponseWindow in SIB1. If a UE detects a PDCCH with its corresponding RA-RNTI within the RAR window and if it successfully decodes the associated PDSCH carrying Msg2, then, the UE will check whether the RAPID contained in the RAR(s) contained in Msg2 matches with its selected preamble index. If so, the UE considers this RAR reception successful. Otherwise, the UE can start a new random-access attempt after the time window expires, until a successful Msg2 reception or it reaches the maximum allowed number of preambles transmissions. According to embodiments, early CSI reporting can be triggered by information in an RAR message.

A 2-step random access procedure, also referred to as Type-2 random access procedure, is illustrated in FIG. 1C.

In the first step of the procedure, a UE sends 120 a message A (MsgA) including a random access preamble together with higher layer data such as the RRC connection request, possibly with some small payload on PUSCH. After detecting the MsgA, the network sends 122 an RAR (referred to as MsgB), including UE identifier assignment, timing advance information, contention resolution message, etc. In this example, the RAR for MsgB is carried by a PDSCH scheduled by PDCCH with CRC scrambled by MsgB-RNTI derived by adding a fixed offset to the RA-RNTI calculated based on the time and frequency resource of the PRACH occasion used for the transmission of the MsgA preamble part (e.g., PRACH). A UE monitors the MsgB in an RAR window (e.g., with maximum length of 40 ms) after the transmission of MsgA. The RAR for MsgB can be a fallback RAR when only the preamble part is detected and the MsgA PUSCH is not correctly decoded. It is a “success” RAR when both the preamble part and MsgA PUSCH part are correctly decoded.

For CSI measurement and feedback, dedicated reference signals called CSI-RS are defined. A CSI-RS resource typically consists of between 1 and 32 CSI-RS ports, and each port is typically transmitted on each transmit antenna (or virtual transmit antenna in case the port is precoded and mapped to multiple transmit antennas). The CSI-RS resource is used by a UE to measure the downlink channel between each of the transmit antenna ports and each of its receive antenna ports. The antenna ports are also referred to as CSI-RS ports. The supported number of antenna ports in NR are currently {1,2,4,8,12,16,24,32}. By measuring the received CSI-RS, a UE can estimate the channel that the CSI-RS is traversing, including the radio propagation channel, potential precoding or beamforming, and antenna gains. The CSI-RS for the above purpose is also referred to as Non-Zero Power (NZP) CSI-RS, but there are also zero power (ZP) CSI-RS used for purposes other than coherent channel measurements. In certain aspects, CSI-RS may be configured to be transmitted in particular resource elements (REs) in a slot and certain slots. FIG. 1D shows an example of a CSI-RS resource mapping 150 of REs for 12 antenna ports, where 1 RE per resource block (RB) per port is shown. According to embodiments, early CSI feedback can be based, at least in part, on CSI-RS.

In addition, an interference measurement resource for CSI feedback (CSI-IM) is also defined in NR for a UE to measure interference. A CSI-IM resource can contain 4 REs, typically either 4 adjacent RE in frequency in the same OFDM symbol or 2 by 2 adjacent REs in both time and frequency in a slot. By measuring both the channel based on NZP CSI-RS and the interference based on CSI-IM, a UE can estimate the effective channel and noise plus interference to determine the CSI (e.g. rank, precoding matrix, and the channel quality). Furthermore, a UE in NR may be configured to measure interference based on one or multiple NZP CSI-RS resource. According to embodiments, early CSI feedback can be based, at least in part, on CSI-IM.

For CSI feedback, NR has adopted an implicit channel state information (CSI) mechanism where a UE feedbacks the downlink CSI, including typically a transmission rank indicator (RI), a precoder matrix indicator (PMI), and channel quality indicator (CQI) for each codeword. The CQI/RI/PMI report can be either wideband or sub-band based on configuration. The RI corresponds to a recommended number of layers that are to be spatially multiplexed and thus transmitted in parallel over the effective channel; the PMI identifies a recommended precoding matrix to use; and the CQI represents a recommended modulation level (e.g., QPSK, 16QAM, etc.) and coding rate for each codeword or transport block (TB). NR supports transmission of one or two codewords to a UE in a slot where two codewords are used for 5 to 8 layer transmission, and one codeword is used for 1 to 4 layer transmission. There is thus a relationship between a CQI and an SINR of the spatial layers over which the codewords are transmitted, and for two codewords there are two CQI values fed back.

In NR, a UE can be RRC configured with multiple CSI reporting settings and multiple CSI resource settings. Different CSI resource settings can be configured for channel and interference measurements. For each CSI reporting setting, a UE feeds back a CSI report. Each CSI resource setting can contain a list of CSI resource sets, where the list is typically a choice between: (a) a list that is comprised of references to either or both of NZP CSI-RS resource set(s) and SSB set(s), or (b) a list comprised of references to CSI-IM resource set(s). Also, each NZP CSI-RS resource set can contain up to 8 NZP CSI-RS resources. The number of CSI-IM resources in a CSI-IM resource set is usually equal to the number of NZP CSI-RS resources in the NZP CSI-RS resource set used for channel measurement. Presently, a CSI reporting setting can contain one or more of the following information: (i) an identifier of resource setting containing NZP CSI-RS resources for channel measurement; (ii) an identifier of resource setting containing CSI-IM resources for interference measurement; (iii) an identifier of resource setting containing NZP CSI-RS resources for interference measurement; (iv) time-domain behavior for CSI reporting (e.g., periodic, semi-persistent, or aperiodic reporting; (v) frequency granularity for CQI and PMI (e.g., wideband CQI vs sub-band CQI, and wideband PMI vs sub-band PMI); (vi) CSI parameters to be reported such as RI, PMI, CQI, layer indicator (LI) and CSI-RS resource indicator (CRI) in the case of multiple NZP CSI-RS resources in a resource set; (vii) codebook configuration, codebook types (e.g., type I or II), and codebook subset restriction; (viii) Measurement restriction; or (ix) information on which CQI table to use for CSI feedback. There are presently 3 different CQI tables defined in NR Rel-15, with different combinations of modulation schemes and code rates suitable for different applications. When a NZP CSI-RS resource set of a CSI resource setting for channel measurement contains multiple NZP CSI-RS resources, one of the NZP CSI-RS resources can be selected by a UE. In this case, a NZP CSI-RS resource indicator (CRI) is also reported by the UE as part of the CSI report to indicate to the gNB about the selected NZP CSI-RS resource in the NZP CSI-RS resource set, together with RI, PMI and CQI associated with the selected NZP CSI-RS resource.

In NR, multiple types of CSI reporting are supported. For “periodic” CSI reporting, CSI is reported periodically by the UE. Parameters such as periodicity and slot offset are configured semi-statically by higher layer signalling from the gNB to the UE. “Aperiodic” CSI reporting (AP CSI Reporting) usually involves a single-shot (i.e., one time) CSI report by the UE, which is typically dynamically triggered by the gNB, e.g. by the DCI in PDCCH. Some of the parameters related to the configuration of the aperiodic CSI report can be semi-statically configured from the gNB to the UE, but the triggering is dynamic. For aperiodic CSI reporting in NR, more than one CSI reporting setting with different CSI resource settings for channel measurement and/or CSI resource settings for interference measurement can be configured and triggered at the same time with a DCI. In this case, multiple CSI reports are aggregated and sent from the UE to the gNB in a single PUSCH transmission. This is done by defining multiple CSI triggering states, with each CSI triggering state including up to 16 CSI reporting settings in NR. A CSI request field in an uplink DCI (e.g., DCI format 0-1) is typically used to select one of the triggering states for CSI reporting. For “semi-persistent” CSI reporting, similar to periodic CSI reporting, the CSI reporting has a periodicity and slot offset which may be semi-statically configured by the gNB to the UE. However, a dynamic trigger from gNB to UE may be needed to allow the UE to begin semi-persistent CSI reporting. In some cases, a dynamic trigger from gNB to UE may be needed to command the UE to stop the semi-persistent transmission of CSI reports.

Similarly, in NR, the following three types of CSI-RS transmissions are presently supported: Periodic CSI-RS (P CSI-RS)—CSI-RS is transmitted periodically in certain slots. This CSI-RS transmission is semi-statically configured using parameters such as CSI-RS resource, periodicity and slot offset. Aperiodic CSI-RS (AP CSI-RS)—This is a one-shot CSI-RS transmission that can happen in any slot. Here, one-shot means that CSI-RS transmission only happens once per trigger. The CSI-RS resources for aperiodic CSI-RS are semi-statically configured. The transmission of aperiodic CSI-RS is triggered by dynamic signalling through PDCCH using the CSI request field in UL DCI. One or multiple aperiodic CSI-RS resource(s) can be included in a CSI-RS resource set and the triggering of aperiodic CSI-RS is on a resource set basis.

Semi-Persistent CSI-RS (SP CSI-RS)—Similar to periodic CSI-RS, resources for semi-persistent CSI-RS transmissions are semi-statically configured with parameters such as periodicity and slot offset. However, unlike periodic CSI-RS, dynamic signalling via MAC CE activation/deactivation is needed to activate/deactivate the CSI-RS transmission.

In the case of aperiodic CSI-RS and/or aperiodic CSI reporting, the gNB RRC can configure the UE with S_{c} CSI triggering states. Each triggering state contains the aperiodic CSI report setting to be triggered along with the associated aperiodic CSI-RS resource sets.

According to embodiments, an aperiodic form of CSI reporting is used for early CSI feedback from high priority devices. For example, an early CSI report on Msg3 PUSCH can be triggered by SIB1 plus a UE priority configuration, or by an UL grant in an RAR, or by an UL grant in a fallback RAR. In some embodiments, an early CSI report on MsgA PUSCH is triggered by SIB1 plus a UE priority configuration. According to embodiments, UEs are configured with priority-based triggering states for early CSI reporting.

Normally, channel state information (CSI) reporting needs to wait until a radio resource control (RRC) connection is complete, and the CSI report is then activated. However, if an early CSI report were enabled, downlink channels in random access could be improved (e.g. with a proper downlink beam or a better MCS). Thus, and according to embodiments, methods and devices are provided for configuring prioritized early CSI feedback for a UE configured with high priority services.

In some embodiments, it is assumed that the network has sufficient information regarding UE priority to decide whether to trigger the early CSI reporting or not. For instance, according to the obtained information on the UE or service priority, a network node can determine whether, and how, to trigger an early CSI report (or CSI feedback or a CSI feedback message) so that it can provide prioritized, fast early CSI feedback from UEs configured with higher priority and provide proper fast link adaptation.

In one embodiment, in a 4-step random access procedure, the early CSI report is triggered for higher priority UEs via enabling the CSI request in the random access response (RAR) message. As an example, if a preamble is detected to be from a high priority UE in a 4-step random access procedure (e.g. based on the preamble ID), the network may enable the “CSI request” bit in the RAR message as is shown in Table A below, which corresponds to Table 8.2-1 in TS 38.213 and describes an RAR grant content field size. Presently, the “CSI request” field is reserved. That is, according to embodiments, the CSI request field may be given a new meaning.

TABLE A

| RAR grant field | Number of bits |
|---|---|
| Frequency hopping flag | 1 |
| PUSCH frequency resource | 14, for operation without shared |
| allocation | spectrum channel access |
| | 12, for operation with |
| | shared spectrum channel access |
| PUSCH time resource allocation | 4 |
| MCS | 4 |
| TPC command for PUSCH | 3 |
| CS/ request | 1 |
| ChannelAccess-CPext | 0, for operation without shared |
| | spectrum channel access |
| | 2, for operation with shared |
| | spectrum channel access |

In one embodiment, for instance where UEs fall back from a 2-step RACH procedure to a 4-step random access procedure, the early CSI report can be triggered for higher priority UEs by enabling the CSI request flag in the fallback random access response message. Similar implementations can be used since the RAR grant content is the same between RAR in 4-step RACH and the fallback RAR in 2-step RACH (i.e., there is an enable “CSI request” bit in the UL grant in a fallback RAR when a MsgA preamble is correctly detected though MsgA PUSCH is not correctly decoded), where the MsgA preamble is determined as a high priority UE based on the preamble ID itself or the PRACH occasion on which the preamble is received.

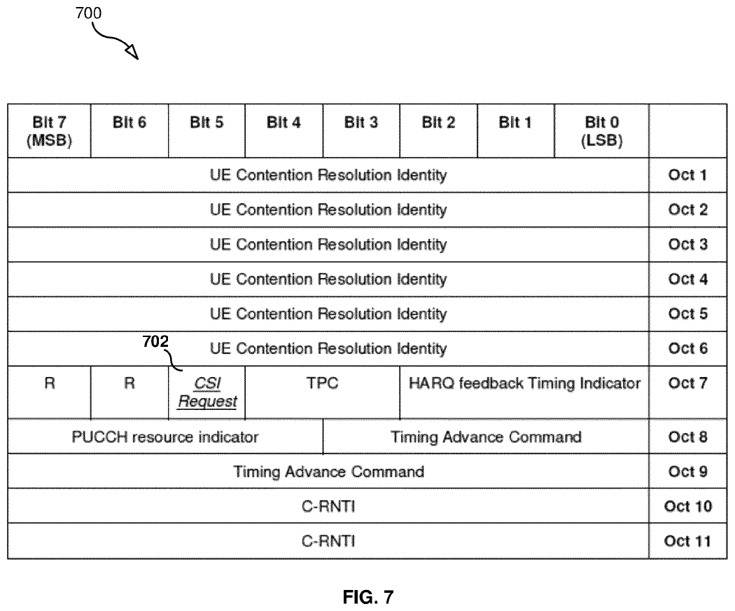

In one embodiment, in a 2-step random access procedure, the early CSI report is triggered by including and enabling the CSI request in the success random access response message (RAR) when a MsgA preamble/PRACH is correctly detected and a MsgA PUSCH is also correctly decoded for a high priority UE. As an example, a 1-bit CSI request field 702 can be included in a success RAR 700 as illustrated in FIG. 7, which can be enabled when a MsgA is detected. For instance, when both the MsgA preamble/PRACH and MsgA PUSCH are successfully decoded, and a high priority UE is indicated by the MsgA.

In a variant of this embodiment, the CSI report can be transmitted on the PUCCH or PUSCH after MsgB transmission. This could include, as an example, the PUCCH for ACK feedback of MsgB, which can be also used to transmit early CSI.

In some embodiments, early CSI reporting is always triggered as long as a high priority UE is detected. In certain aspects, no additional signaling is needed to enable the early CSI feedback. Here, the CSI report can thus be expected to be transmitted in one or more of a Msg3 PUSCH in 4-step random access procedure; MsgA PUSCH in 2-step random access procedure; Msg3 PUSCH scheduled by fallback RAR in the fallback from a 2-step random access procedure to a 4-step random access procedure; and/or an early PUCCH. Examples of an early PUCCH could include the PUCCH for ACK feedback of success reception of contention resolution message in Msg4 in a 4-step random access procedure, or the PUCCH for ACK feedback of successful reception of a success RAR in a 2-step random access procedure.

In some embodiments, early CSI reporting is enforced by a high priority UE based on its configured priority information and the system information received from the network. In certain aspects, these methods may not require a network node to know the priority of a given UE.

For instance, in an embodiment, early CSI reporting for UEs with different priorities is enabled or disabled by broadcasted system information.

In embodiments, early CSI reporting is enforced by a UE based on its configured access identit(ies) or/and access category. As an example, the UE priority can be defined by the UE Access Identity. In this case, a UE itself checks if it should apply early CSI reporting. This can be done by checking the broadcasted system information received from the network node to see whether an early CSI report is enabled for its configured access identity. This may similarly apply to access category.

As an example, in a NR implementation, Access Identity 1 and Access Identity 2 are used for UEs configured with multimedia priority services and mission critical services, respectively. In addition, NR Rel-16 has introduced a field ra-PrioritizationforAccessIdentity in the RACH-ConfigCommon IE in SIB1, with the purpose of supporting the configuration of prioritized PRACH retransmission for 4-step random access procedures. The parameter, ra-PriofitizationForAl-r16, in the field ra-PrioritizationforAccessIdentity is a 2-bit bitmap, which indicates whether Access Identity 1 (for UEs configured with multimedia priority services), or Access Identity 2 (for UEs configured with mission critical services) are enabled for prioritized PRACH or not. An example is shown below:

[[

| | |
|---|---|
| ra-PrioritizationForAccessIdentity | SEQUENCE { |

| | |
|---|---|
| ra-Prioritization-r16 | RA-Prioritization, |
| ra-PrioritizationForAI-r16 | BIT STRING (SIZE (2)) |

| | |
|---|---|
| } | OPTIONAL -- Need R |

]]

Similar signaling has been introduced in NR Rel-16 for the 2-step random access procedure, e.g., in ra-PrioritizationForAccessIdentityTwoStep-r16 in RACH-ConfigCommonTwoStepRA IE in SIB1. An example is shown below:

| | |
|---|---|
| ra-PrioritizationForAccessIdentityTwoStep-r16 | SEQUENCE { |

| | | |
|---|---|---|
| ra-Prioritization-r16 | RA-Prioritization | OPTIONAL, -- Need M |
| ra-PrioritizationForAI-r16 | BIT STRING (SIZE (2)) | OPTIONAL -- Need M |

| | |
|---|---|
| } | OPTIONAL, -- Need R |

According to embodiments, the legacy field ra-PrioritizationforAccessIdentity in the RACH-ConfigCommon IE in SIB1 can be reused for a network node to enable early CSI reporting. Similarly, the existing field ra-PrioritizationForAccessIdentityTwoStep-r16 in the RACH-ConfigCommonTwoStepRA IE in SIB1 can be reused to enable early CSI reporting. The parameter, ra-PrioritizationForAl-r16, in the field ra-PrioritizationforAccessIdentity is a 2-bit bitmap, which indicates whether Access Identity 1 (for UEs configured with multimedia priority services), or Access Identity 2 (for UEs configured with mission critical services) are enabled. This parameter can be reused to enable or disable early CSI reporting for UEs with Access identity 1 and/or 2. When the field is present in SIB1, it indicates that early CSI reporting for UEs configured with the Access Identity 1 and/or 2 is enabled for that network node.

In an embodiment, different CSI reporting settings for the early CSI report are configured in broadcasted system information for different UE priorities.

In an embodiment, the CSI reporting settings for the early CSI report for mission critical UEs and/or multimedia priority UEs are configured in the field ra-PrioritizationforAccessIdentity in the RACH-ConfigCommon IE in SIB1 for four-step random access procedures, and in the field ra-PrioritizationForAccessIdentityTwoStep-r16 in RACH-ConfigCommonTwoStepRA IE in SIB1 for two-step random access procedures.

In an embodiment, the CSI request signaling received via RAR can override the early CSI report configuration received from the broadcasted system information, or other configurations previously received via broadcast.

According to embodiments, a network node or UE can combine one or more of the embodiments disclosed herein. For instance, there may be a situation where certain knowledge is had by both a UE and the node. In other instance, an embodiment may use different configuration settings, messages, and or indicators disclosed herein in combination with each other.

In embodiments, a random access response (RAR) messages may be a random access response message in a 4-step random access procedure, or a fallback random access response message in a 2-step random access procedure, or a success random access response message in a 2-step random access procedure, or another random access response message. While 2- and 4-step random access procedures are used as examples, the methods and devices described herein can be used with other procedures—including other access procedures—to enable early CSI reporting for selected categories of devices, such as devices for mission critical services.

Referring now to FIG. 2 a communication system 200 is shown according to some embodiments. The system may, for instance, implement 5G new radio (NR) and include a first node 203, a second node 204, a first UE 201, and a second UE 202. The nodes may be, for instance, base stations, such as NBs, eNBs, gNBs or other types of wireless access points or network nodes. The UEs may be any form of UE according to embodiments, such as mobile telephones, personal digital assistants, electronic readers, portable electronic tablets, wireless sensors, machine communication devices, personal computers, and laptop computers. UEs 201 and 202 may communicate, for instance, with one or more of the nodes (e.g., node 204). The nodes may similarly communicate with each other. In some embodiments, one or more devices have access to network 210.

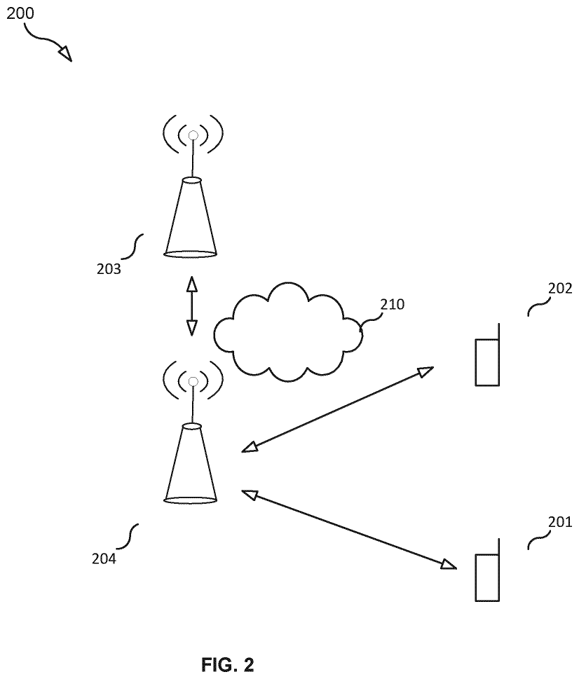

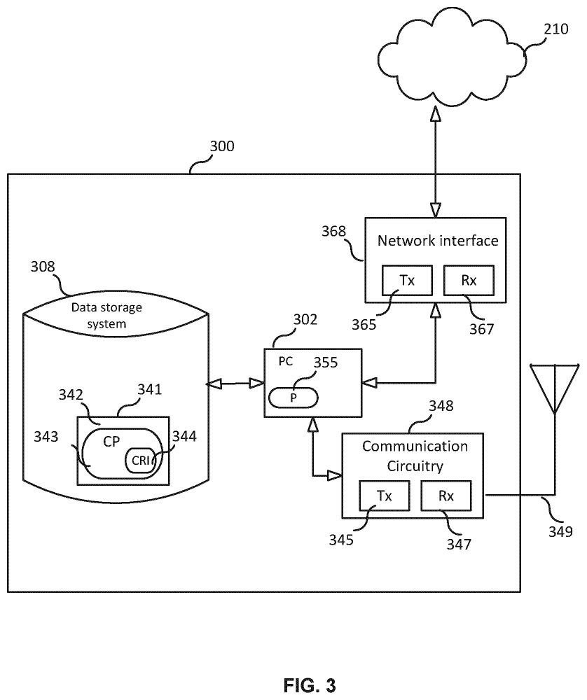

Referring now to FIG. 3, FIG. 3 is a block diagram of an apparatus 300 (e.g., a network node such as nodes 203, 204), according to some embodiments. As shown in FIG. 3, apparatus 300 may comprise: processing circuitry (PC) 302, which may include one or more processors (P) 355 (e.g., one or more general purpose microprocessors and/or one or more other processors, such as an application specific integrated circuit (ASIC), field-programmable gate arrays (FPGAs), and the like), which processors may be co-located in a single housing or in a single data center or may be geographically distributed (i.e., apparatus 300 may be a distributed computing apparatus); a network interface 368 comprising a transmitter (Tx) 365 and a receiver (Rx) 367 for enabling apparatus 300 to transmit data to and receive data from other nodes connected to a network 210 (e.g., an Internet Protocol (IP) network) to which network interface 368 is connected; communication circuitry 348, which is coupled to an antenna arrangement 349 comprising one or more antennas and which comprises a transmitter (Tx) 345 and a receiver (Rx) 347 for enabling apparatus 300 to transmit data and receive data (e.g., wirelessly transmit/receive data); and a local storage unit (a.k.a., “data storage system”) 308, which may include one or more non-volatile storage devices and/or one or more volatile storage devices. In embodiments where PC 302 includes a programmable processor, a computer program product (CPP) 341 may be provided. CPP 341 includes a computer readable medium (CRM) 342 storing a computer program (CP) 343 comprising computer readable instructions (CRI) 344. CRM 342 may be a non-transitory computer readable medium, such as, magnetic media (e.g., a hard disk), optical media, memory devices (e.g., random access memory, flash memory), and the like. In some embodiments, the CRI 344 of computer program 343 is configured such that when executed by PC 302, the CRI causes apparatus 300 to perform steps described herein (e.g., steps described herein with reference to the flow charts). In other embodiments, apparatus 300 may be configured to perform steps described herein without the need for code. That is, for example, PC 302 may consist merely of one or more ASICs. Hence, the features of the embodiments described herein may be implemented in hardware and/or software.

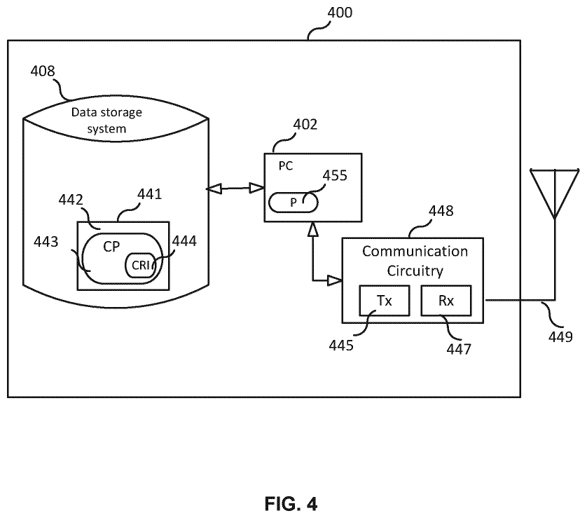

Referring now to FIG. 4, FIG. 4 is a block diagram of device (e.g., a UE such as UEs 201, 202), according to some embodiments. As shown in FIG. 4, UE 201, 202 may comprise: processing circuitry (PC) 402, which may include one or more processors (P) 455 (e.g., one or more general purpose microprocessors and/or one or more other processors, such as an application specific integrated circuit (ASIC), field-programmable gate arrays (FPGAs), and the like); communication circuitry 448, which is coupled to an antenna arrangement 449 comprising one or more antennas and which comprises a transmitter (Tx) 445 and a receiver (Rx) 447 for enabling UE 201, 2020 to transmit data and receive data (e.g., wirelessly transmit/receive data); and a local storage unit (a.k.a., “data storage system”) 408, which may include one or more non-volatile storage devices and/or one or more volatile storage devices. In embodiments where PC 402 includes a programmable processor, a computer program product (CPP) 441 may be provided. CPP 441 includes a computer readable medium (CRM) 442 storing a computer program (CP) 443 comprising computer readable instructions (CRI) 444. CRM 442 may be a non-transitory computer readable medium, such as, magnetic media (e.g., a hard disk), optical media, memory devices (e.g., random access memory, flash memory), and the like. In some embodiments, the CRI 444 of computer program 443 is configured such that when executed by PC 402, the CRI causes UE 201, 202 to perform steps described herein (e.g., steps described herein with reference to the flow charts). In other embodiments, UE 201, 202 may be configured to perform steps described herein without the need for code. That is, for example, PC 402 may consist merely of one or more ASICs. Hence, the features of the embodiments described herein may be implemented in hardware and/or software.

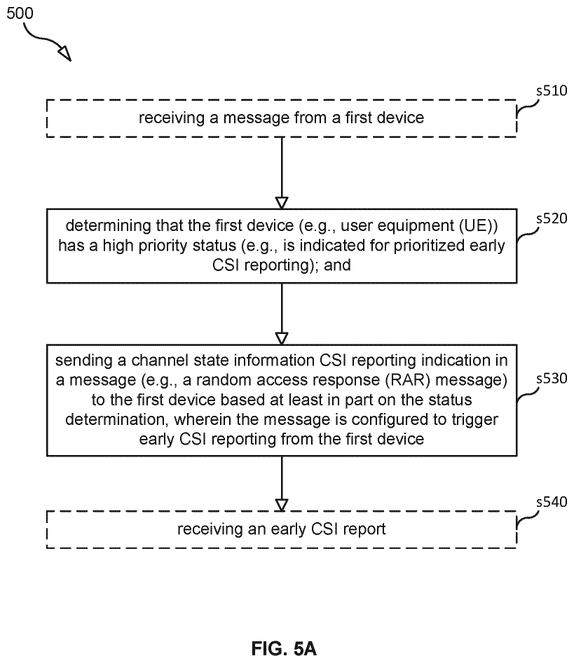

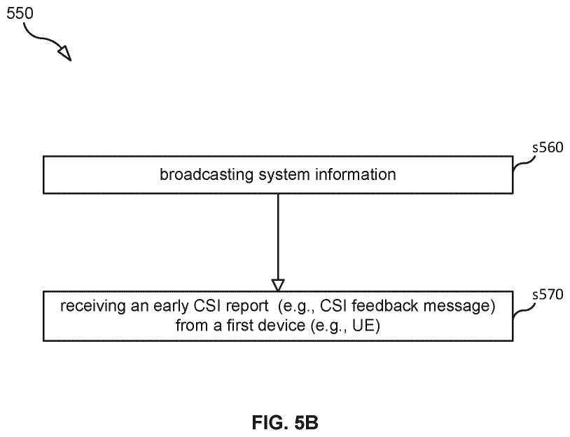

Referring now to FIGS. 5A and 5B, one or more methods are provided for a node (e.g., gNB) to enable and/or receive early CSI reports from a device (e.g., UE), for instance, based on the UE's status. For instance, the methods may be used where one or more UEs in communication with the node are associated with an essential public safety service (e.g., mission critical services such as mission critical push-to-talk, mission critical data, or mission critical video for fire-fighters, police, or emergency medical service providers). In some embodiments, the node may have knowledge of a specific UE's status. In other embodiments, the node may authorize (and receive) early CSI reports without knowing any UE's specific priority. In some embodiments, one or more messages in the processes of FIGS. 5A and 5B are part of a 2- or 4-step random access procedure in which one of more access messages are exchanged between the UE and node.

FIG. 5A illustrates a process 500 according to some embodiments. The process may be performed, for instance, by a node 203, 204 in communication with one or more UEs, such as UEs 201, 202 in system 200.

The process may being with step s510, in which the node receives a message from a first device (e.g., UE 201, 202). In some embodiments, this step may be optional.

In step s520, the node determines that the first device has a high priority status (e.g., is indicated for prioritized early CSI reporting). This may be based, for instance, on the message received in step s510. For instance, a preamble ID or a physical random-access channel (PRACH) occasion of the received message can indicate that the first device has a high priority status.

In step s530, the node sends a channel state information CSI reporting indication in a message (e.g., in a random access response (RAR) message) to the first device based at least in part on the status determination. In certain aspects, the message is configured to trigger early CSI reporting from the first device. The indication may comprise, for instance, enabling one or more bits or flags in a message to the device.

In step s540, which may be optional in some embodiments, the node receives an early CSI report. The early CSI report may be received (or transmitted by the UE) before completion of an RRC connection between the UE and node, and in some instance, as part of the random access procedure (e.g., in an ACK feedback).

FIG. 5B illustrates a process 550 according to some embodiments. The process may be performed, for instance, by a node 203, 204 in communication with one or more UEs, such as UEs 201, 202 in system 200. According to embodiments, the UE has a high priority status. However, the process 550 does not require that the node has knowledge of the UE's status.

The process may begin with step s560, in which the node broadcasts system information. In step s570, the node receives an early CSI report from a device (e.g., UE 201, 202). The early CSI report may be received (or transmitted by the UE) before completion of an RRC connection between the UE and node, and in some instance, as part of the random access procedure (e.g., in an ACK feedback).

In certain aspects, the system information broadcasted from the node comprises one or more CSI settings, and the one or more CSI settings are different for different device (e.g., UE) priorities or service types. For instance, the system information broadcasted from the node can indicate one or more device or service types enabled for early CSI reporting (e.g., for mission critical communications). In this respect, prioritized devices for early CSI reporting can be identified based on one or more of access identity and access category.

According to embodiments, the SSB or CSI-RS downlink signals can be configured in system information and transmitted periodically, such that a UE has sufficient information to perform (and report) measurements before completion or during a random access procedure.

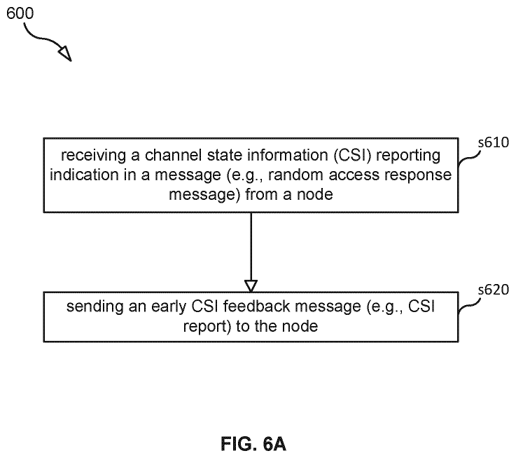

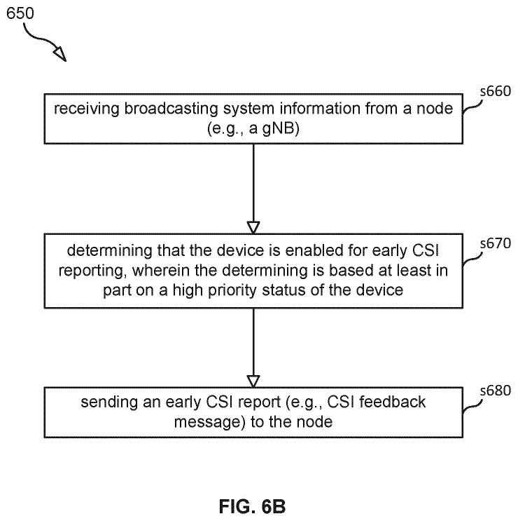

Referring now to FIGS. 6A and 6B, one or more methods are provided for a device (e.g., UE) to provide early CSI feedback to a node (e.g. a gNB), for instance, based on the UE's status. For example, the methods may be used where a UE is associated with an essential public safety service (e.g., mission critical services such as mission critical push-to-talk, mission critical data, or mission critical video for fire-fighters, police, or emergency medical service providers). In some embodiments, one or more messages in the processes of FIGS. 6A and 6B are part of a 2- or 4-step random access procedure in which one of more access messages are exchanged between the UE and node.

FIG. 6A illustrates a process 600 according to some embodiments. The process may be performed, for instance, by a UE 201, 202 in communication with one or more nodes, such as nodes 203, 204 in system 200.

The process may begin with step s610, in which the UE receives a CSI reporting indication in a message (e.g., an RAR message) from the node. In some embodiments, the indication may override one more settings previously in place (e.g., based on a broadcast from the node). The indication may comprise, for instance, one or more bits or flags in a particular field/parameter of the message.

In step s620, the UE sends the early feedback message to the node. According to embodiments the feedback is sent to the node before completion of an RRC connection between the UE and node, and in some instance, as part of the random access procedure (e.g., in an ACK feedback). The CSI feedback message may comprise, for example, one or more of a transmission rank indicator (RI), a precoder matrix indicator (PMI), and a channel quality indicator (CQI) for a codeword.

In order to derive the content of the CSI report, the UE may measure one or more CSI-RS and CSI-IM from the node. The UE may similarly use one or more CSI settings from a broadcast of the node (or via other network information) to generate the CSI feedback.

FIG. 6B illustrates a process 650 according to some embodiments. The process may be performed, for instance, by a UE 201, 202 in communication with one or more nodes, such as nodes 203, 204 in system 200.

The process may begin, for instance, in step s660, in which the UE receives system broadcast information form the node.

In step s670, the UE determines that it is enabled for early CSI reporting. This can be based, for instance, on the status of the UE as well as the broadcast information. For instance, the broadcast information may indicate that the UE's category/status/service type is enabled for early CSI reporting (e.g., based on access identity and/or access category). As an example, prioritized devices can be indicated by a parameter (e.g., ra-PrioritizationForAl-r16) in a prioritization field (e.g., ra-PrioritizationforAccessIdentity or ra-PrioritizationForAccessIdentityTwoStep-r16) of a broadcast message (e.g., in the RACH-ConfigCommon IE of SIB1 or RACH-ConfigCommonTwoStepRA IE in SIB1) received from the node

In step s680, the UE sends an early CSI report. As with the process 600, according to embodiments, the feedback is sent to the node before completion of an RRC connection between the UE and node, and in some instance, as part of the random access procedure (e.g., in an ACK feedback). The CSI feedback message may comprise, for example, one or more of a transmission rank indicator (RI), a precoder matrix indicator (PMI), and a channel quality indicator (CQI) for a codeword. Additionally, in order to derive the content of the CSI report, the UE may measure one or more CSI-RS and CSI-IM from the node. The UE may similarly use one or more CSI setting from a broadcast of the node (or via other network information) to generate the CSI feedback.

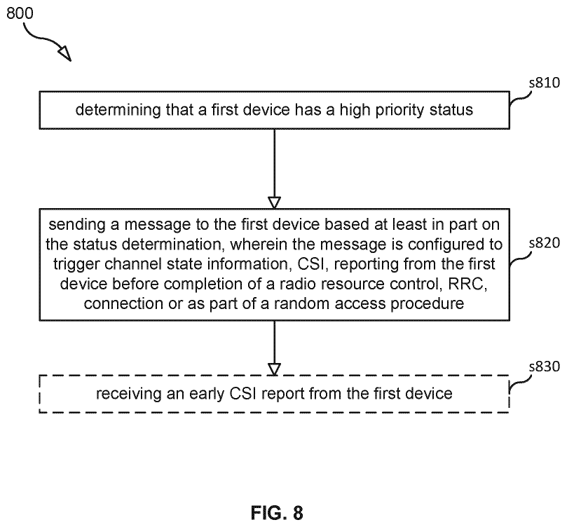

According to embodiments, an early CSI report (e.g., as part of process 500, 550, 600, or 650) is sent as part of: (i) a Msg3 PUSCH in a 4-step random access procedure; (ii) a MsgA PUSCH in a 2-step random access procedure; (iii) a Msg3 PUSCH scheduled by fallback RAR in the fallback from a 2-step random access procedure to a 4-step random access procedure; and/or (iv) an early PUCCH (e.g., a PUCCH for ACK feedback of success reception of contention resolution message in Msg4 of a 4-step random access procedure or the PUCCH for ACK feedback of successful reception of a success RAR in a 2-step random access procedure). Similar messaging may be used for the methods of FIGS. 8-11.

According to embodiments, the CSI settings for early reporting may be different than the CSI settings for regular reporting. This may be indicated by broadcast, for instance.

According to embodiments, the information (e.g., messages) from a node may not only enable early CSI reporting, but also disable early CSI reporting depending on the indication (e.g., based on the indications content or value).

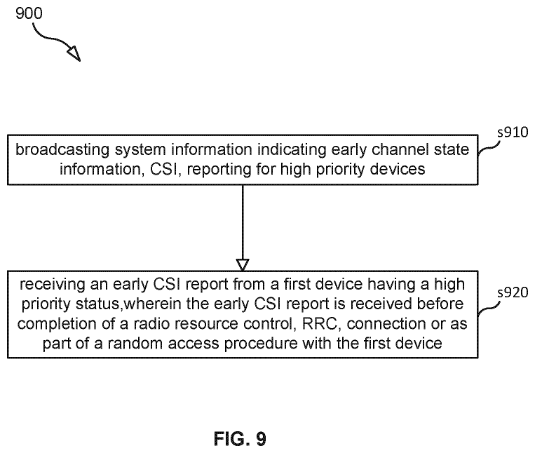

Referring now to FIGS. 8 and 9, one or more methods are provided for a node (e.g., gNB) to enable and/or receive early CSI reports from a device (e.g., UE), for instance, based on the UE's status. For instance, the methods may be used where one or more UEs in communication with the node are associated with an essential public safety service (e.g., mission critical services such as mission critical push-to-talk, mission critical data, or mission critical video for fire-fighters, police, or emergency medical service providers). In some embodiments, the node may have knowledge of a specific UE's status. In other embodiments, the node may authorize (and receive) early CSI reports without knowing any UE's specific priority. In some embodiments, one or more messages in the processes of FIGS. 8 and 9 are part of a 2- or 4-step random access procedure in which one of more access messages are exchanged between the UE and node.

FIG. 8 illustrates a process 800 according to some embodiments. The process may be performed, for instance, by a node 203, 204 in communication with one or more UEs, such as UEs 201, 202 in system 200. The process may begin with step s810, which comprises determining that a first device has a high priority status. In some embodiments, determining that the first device has a high priority status is based at least in part on a preamble ID received from the first device or a PRACH occasion on which a preamble was transmitted to the node from the first device. In step s820, the node sends a message to the first device based at least in part on the status determination, wherein the message is configured to trigger channel state information, CSI, reporting from the first device before completion of a radio resource control, RRC, connection or as part of a random access procedure. The message may be, for instance, an RAR message (e.g., with a CSI request bit enabled). In step s830, which may be optional in some embodiments, the node receives an early CSI report from the first device. In embodiments, the early CSI report is received before completion of an RRC connection or in a message as part of a random access procedure. According to some embodiments, the received early CSI report is related to one or more of CSI-RS and CSI-IM signalled from the node (e.g., via broadcast system information).

FIG. 9 illustrates a process 900 according to some embodiments. The process may be performed, for instance, by a node 203, 204 in communication with one or more UEs, such as UEs 201, 202 in system 200. The process may being with step s910, which comprises broadcasting system information indicating early channel state information, CSI, reporting for high priority devices. This may be, for instance, based on one or more of access identity and/or access category. Broadcast CSI settings can be different for different device priorities or service types, including enabling or disabling early CSI reporting. In step s920, the node receives an early CSI report from a first device having a high priority status, wherein the early CSI report is received before completion of a radio resource control, RRC, connection or as part of a random access procedure with the first device. In some embodiments, the process 900 may further comprise sending a message from the node to the first device that is configured to override one or more CSI settings sent in a broadcast of system information.

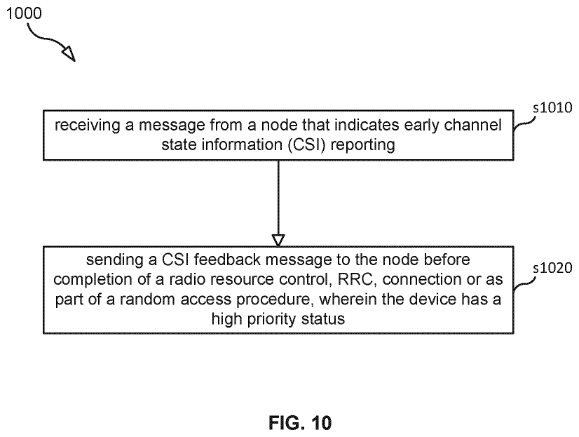

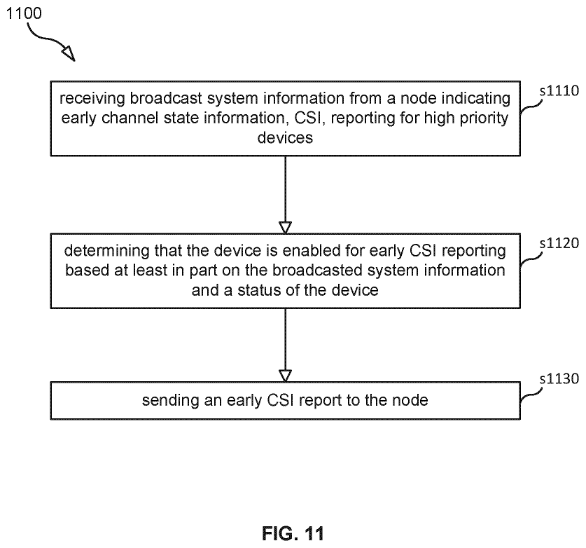

Referring now to FIGS. 10 and 11, one or more methods are provided for a device (e.g., UE) to provide early CSI feedback to a node (e.g. a gNB), for instance, based on the UE's status. For example, the methods may be used where a UE is associated with an essential public safety service (e.g., mission critical services such as mission critical push-to-talk, mission critical data, or mission critical video for fire-fighters, police, or emergency medical service providers). In some embodiments, one or more messages in the processes of FIGS. 10 and 11 are part of a 2- or 4-step random access procedure in which one of more access messages are exchanged between the UE and node.

FIG. 10 illustrates a process 1000 according to some embodiments. The process may be performed, for instance, by a UE 201, 202 in communication with one or more nodes, such as nodes 203, 204 in system 200. The process may begin with step s1010, which comprises receiving a message from a node that indicates early channel state information (CSI) reporting. The message may be, for instance, an RAR message with a CSI request bit enabled. In step s1020, the device sends a CSI feedback message to the node before completion of a radio resource control, RRC, connection or as part of a random access procedure, wherein the device has a high priority status. The feedback may be, for example, based on one or more of CSI-RS and/or CSI-IM signalled from the node. In some embodiments, process 1000 may further comprising receiving system information broadcast from the node that comprises one or more CSI settings, wherein the early CSI reporting indication received from the node overrides one or more CSI setting of the broadcast.

FIG. 11 illustrates a process 1100 according to some embodiments. The process may be performed, for instance, by a UE 201, 202 in communication with one or more nodes, such as nodes 203, 204 in system 200. The process may begin with step s1110, which comprises receiving broadcast system information from a node indicating early channel state information, CSI, reporting for high priority devices. In step s1120, the device determines that it is enabled for early CSI reporting based at least in part on the broadcasted system information and a status of the device. In step s1130, the device sends an early CSI report to the node. In some embodiments, the CSI report is sent before completion of a radio resource control, RRC, connection or as part of a random access procedure. In some embodiments, the broadcasted system information indicates early CSI reporting for devices based on one or more of access identity and/or access category and the determining is based at least in part on one or more of an access identity and/or access category of the device.

### Summary of Various Embodiments

A1. A method in a node (e.g., a gNB), comprising: determining that a first device (e.g., user equipment (UE)) has a high priority status (e.g., is indicated for prioritized early CSI reporting); and sending a channel state information CSI reporting indication in a message (e.g., in a random access response (RAR) message) to the first device based at least in part on the status determination, wherein the message is configured to trigger early CSI reporting from the first device.

A2. The method of A1, wherein the random access response is an RAR grant message sent as part of a 4-step random access procedure.

A3. The method of A2, wherein the message is configured with a CSI request bit enabled.

A4. The method of A1, wherein the random access response is fallback response message (e.g., the message indicates that the first device shall fall back from a 2-step random-access channel (RACH) procedure to 4-step random access procedure).

A5. The method of any of A1-A4, wherein the indication comprises a CSI request bit enabled in an uplink grant.

A6. The method of A1, further comprising: receiving a message from the first device; successfully decoding the received message preamble (e.g., a MsgA preamble/PRACH), wherein the preamble or a physical random-access channel (PRACH) occasion of the received message indicates that the first device has a high priority status; an determining that another portion (e.g., a MsgA physical uplink shared channel (PUSCH)) of the received message was not correctly decoded.

A7. The method of A1, further comprising: receiving a message from the first device; and successfully decoding the received message (e.g., a MsgA preamble/PRACH and a MsgA PUSCH), wherein the preamble or a PRACH occasion of the received message indicates that the first device has a high priority status, wherein the message sent to the first device is a success random access response message and the indication comprises an included/enabled CSI request bit.

A8. The method of any of A1-A7, wherein determining that the first device is a high priority device is based at least in part on (i) a preamble ID received from the first device (e.g., detecting that a preamble received from the first device corresponds to a high priority device), and/or (ii) a PRACH occasion on which a preamble was received form the first device.

A9. The method of any of A1-A8, further comprising: receiving an early CSI report (e.g., CSI feedback message) from the first device.

A10. The method of A9, wherein the early CSI report is received (e.g., was sent by the first device) before completion of an RRC connection between the UE and the node.

A11. The method of A9 or A10, wherein the early CSI report is received as part of a random access procedure (e.g., transmitted on the physical uplink control channel (PUCCH) or PUSCH after MsgB transmission, such as for ACK feedback of MsgB).

A12. The method of any of A1-A11, wherein the CSI report comprises one or more of a transmission rank indicator (RI), a precoder matrix indicator (PMI), and a channel quality indicator (CQI) for a codeword.

A13. The method of any of A9-A12, further comprising: broadcasting system information from the node, wherein the received early CSI report is related to one or more of CSI-RS and CSI-IM signalled from the node.

B1. A method in a node (e.g., a gNB), comprising: broadcasting system information; and receiving an early CSI report (e.g., CSI feedback message) from a first device (e.g., UE).

B2. The method of B1, wherein the first device has a high priority status.

B3. The method of B1 or B2, wherein the early CSI report is received (e.g., transmitted from the device) before an RRC connection is established between the first device and the node.

B4. The method of any of B1-133, further comprising: receiving one or more random access procedure messages from the first device, wherein the CSI report is received as part of the random access procedure (or before the procedure is complete).

B5. The method of B4, wherein the early CSI report is received as part of: (i) a Msg3 PUSCH in a 4-step random access procedure; (ii) a MsgA PUSCH in a 2-step random access procedure; (iii) a Msg3 PUSCH scheduled by fallback RAR in the fallback from a 2-step random access procedure to a 4-step random access procedure; and/or (iv) an early PUCCH (e.g., a PUCCH for ACK feedback of success reception of contention resolution message in Msg4 of a 4-step random access procedure or the PUCCH for ACK feedback of successful reception of a success RAR in a 2-step random access procedure).

B6. The method of any of B1-135, wherein the system information broadcasted from the node comprises one or more CSI settings, and wherein the one or more CSI settings are different for different device (e.g., UE) priorities or service types.

B7. The method of any of B1-136, wherein the system information broadcasted from the node indicates one or more device or service types enabled for early CSI reporting (e.g., for mission critical communications).

B8. The method of B7, wherein prioritized devices for early CSI reporting are identified based on one or more of access identity and access category (e.g., broadcasting an identification of access identity or access category authorized for early CSI reporting).

B9. The method of B8, wherein prioritized devices are indicated by a parameter (e.g., ra-PrioritizationForAl-r16) in a prioritization field (e.g., ra-PrioritizationforAccessIdentity or ra-PrioritizationForAccessIdentityTwoStep-r16) of a broadcast message (e.g., in the RACH-ConfigCommon IE of SIB1 or RACH-ConfigCommonTwoStepRA IE in SIB1).

B10. The method of B9, wherein the parameter comprises a 2-bit bitmap.

B11. The method of B9 or B10, wherein the indication further comprises an indication of CSI settings for early CSI reporting.

B12. The method of any of B1-B8, wherein the system information broadcasted from the node indicates one or more device or service types disabled for early CSI reporting.

B13. The method of any of B1-B12, wherein a message from the node (e.g., an RAR message) to the first device and is configured to override one or more CSI settings sent in the broadcast of system information.

C1. A network node (e.g., a gNB) configured to perform one or more of the methods A1-A13 or B1-B13.

D1. A computer program comprising instructions which when executed by processing circuitry of an apparatus causes the apparatus to perform the method of any one of the methods A1-A13 or B1-B13.

D2. A carrier containing the computer program of D1, wherein the carrier is one of an electronic signal, an optical signal, a radio signal, and a computer readable storage medium.

E1. A method in a device (e.g., a UE), comprising: receiving a channel state information (CSI) reporting indication in a message (e.g., random access response message) from a node; and sending an early CSI feedback message (e.g., CSI report) to the node, wherein the device has a high priority status.

E2. The method of E1, further comprising: receiving system information broadcast from the node that comprises one or more CSI settings.

E3. The method of E2, wherein the CSI reporting indication received from the node overrides one or more CSI setting of the broadcast.

E4. The method of any of E1-E3, wherein the random access response is an RAR grant message received as part of a 4-step random access procedure.

E5. The method of E4, wherein the message is configured with a CSI request bit enabled.

E6. The method of any of E1-E3, wherein the random access response is fallback response message (e.g., the message indicates that the device shall fall back from a 2-step RACH procedure to 4-step random access procedure).

E7. The method of E6, wherein the indication comprises a CSI request bit enabled in an uplink grant.

E8. The method of any of E1-E7, wherein the early CSI feedback message is sent before completion of an RRC connection between the device and the node.

E9. The method of any of E1-E8, wherein the early CSI feedback message is sent as part of a random access procedure (e.g., sent on the PUCCH or PUSCH after MsgB reception, such as for ACK feedback on MsgB).

E10. The method of any of E1-E9, wherein the CSI feedback message comprises one or more of a transmission rank indicator (RI), a precoder matrix indicator (PMI), and a channel quality indicator (CQI) for a codeword.

E11. The method of E10, wherein the CSI feedback message is based on a measurement of one or more CSI-RS and CSI-IM from the node.

F1. A method in a device (e.g., a UE), comprising: receiving broadcasting system information from a node (e.g., a gNB); determining that the device is enabled for early CSI reporting, wherein the determining is based at least in part on a high priority status of the device; and sending an early CSI report (e.g., CSI feedback message) to the node.

F2. The method of F1, wherein the status determination is based on one or more of an access identity or access category of the device.

F3. The method of F1 or F2, wherein the early CSI report is sent before an RRC connection is established between the device and the node.

F4. The method of any of F1-F3, wherein the early CSI report is sent as part of a random access procedure (or before the procedure is complete).

F5. The method of F4, wherein the early CSI report is sent as part of: (i) a Msg3 PUSCH in a 4-step random access procedure; (ii) a MsgA PUSCH in a 2-step random access procedure; (iii) a Msg3 PUSCH scheduled by fallback RAR in the fallback from a 2-step random access procedure to a 4-step random access procedure; and/or (iv) an early PUCCH (e.g., a PUCCH for ACK feedback of success reception of contention resolution message in Msg4 of a 4-step random access procedure or the PUCCH for ACK feedback of successful reception of a success RAR in a 2-step random access procedure).

F6. The method of any of F1-F5, wherein the system information received from the node comprises one or more CSI settings, and wherein the one or more CSI settings are different for different device (e.g., UE) priorities (e.g., categories or service type).

F7. The method of any of F1-F6, wherein the system information received from the node indicates one or more device or service types enabled for early CSI reporting (e.g., for mission critical communications).

F8. The method of F7, wherein prioritized devices for early CSI reporting are identified based on one or more of access identity and access category (e.g., the device receives an identification of access identity or access category authorized for early CSI reporting).

F9. The method of F8, wherein prioritized devices are indicated by a parameter (e.g., ra-PrioritizationForAl-r16) in a prioritization field (e.g., ra-PrioritizationforAccessIdentity or ra-PrioritizationForAccessIdentityTwoStep-r16) of a broadcast message (e.g., in the RACH-ConfigCommon IE of SIB1 or RACH-ConfigCommonTwoStepRA IE in SIB1) received from the node.

F10. The method of F9, wherein the parameter comprises a 2-bit bitmap.

F11. The method of F9 or F10, wherein the indication further comprises an indication of CSI settings for early CSI reporting.

F12. The method of any of F1-F11, wherein the system information received from the node further indicates one or more device or service types disabled for early CSI reporting.

F13. The method of any of F1-F12, wherein a message received from the node (e.g., an RAR message) overrides one or more CSI settings received in the broadcast of system information.

G1. A network node (e.g., a gNB) configured to perform one or more of the methods E1-E11 or F1-F13.

H1. A computer program comprising instructions which when executed by processing circuitry of an apparatus causes the apparatus to perform the method of any one of the methods E1-E11 or F1-F13.

H2. A carrier containing the computer program of H1, wherein the carrier is one of an electronic signal, an optical signal, a radio signal, and a computer readable storage medium.

While various embodiments are described herein, it should be understood that they have been presented by way of example only, and not limitation. Thus, the breadth and scope of this disclosure should not be limited by any of the above described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1-45. (canceled)

46. A method in a node, comprising:
determining that a first device has a high priority status; and
sending a message to the first device based at least in part on the status determination, wherein the message is configured to trigger channel state information (CSI) reporting from the first device before completion of a radio resource control (RRC) connection or as part of a random access procedure.

47. The method of claim 46, wherein determining that the first device has a high priority status is based at least in part on a preamble ID received from the first device or a physical random-access channel (PRACH) occasion on which a preamble was transmitted to the node from the first device.

48. The method of claim 46, wherein the message to the first device is a random access response (RAR) message.

49. The method of claim 46, wherein the message to the first device is configured with a CSI request bit enabled.

50. The method of claim 46, further comprising:
receiving an early CSI report from the first device, wherein the message to the first device is configured with a CSI request bit enabled.

51. The method of claim 50, wherein:
(i) the early CSI report is received in a Msg3 of a 4-step random access procedure;
(ii) the early CSI report is received in a Msg3 of a fallback random access procedure;
(iii) the early CSI report is received in an acknowledgement feedback for successful reception of contention resolution in a 4-step random access procedure; or
(iv) the early CSI report is received in an acknowledgement feedback for successful reception of RAR in a 2-step random access procedure.

52. The method of claim 46, wherein:
(i) the message to the first device is a Msg2 in a 4-step random access procedure;
(ii) the message to the first device is a MsgB in a 2-step random access procedure;
(iii) the message to the first device is a fallback RAR message;
(iv) the message to the first device is an RAR grant message;
(v) determining that the first device has a high priority is based at least in part on decoding a Msg1 received from the first device in a 4-step random access procedure; or
(vi) determining that the first device has a high priority is based at least in part on decoding a MsgA received from the first device in a 2-step random access procedure.

53. The method of claim 46, wherein the early CSI report comprises one or more of a transmission rank indicator (RI), a precoder matrix indicator (PMI), and a channel quality indicator (CQI) for a codeword.

54. The method of claim 50, further comprising:
broadcasting system information from the node,
wherein the received early CSI report is related to one or more of CSI-RS or CSI-IM signalled from the node.

55. A method in a node, comprising:
broadcasting system information indicating early channel state information (CSI) reporting for high priority devices; and
receiving an early CSI report from a first device having a high priority status, wherein the early CSI report is received before completion of a radio resource control (RRC) connection or as part of a random access procedure with the first device.

56. The method of claim 55, wherein the broadcasted system information indicates early CSI reporting for devices based on one or more of access identity or access category.

57. The method of claim 55, wherein:
(i) the broadcasted system information comprises one or more CSI settings, and wherein the one or more CSI settings are different for different device priorities or service types;
(ii) the broadcasted system information indicates one or more device or service types enabled for early CSI reporting; or
(iii) the broadcasted system information indicates one or more device or service types disabled for early CSI reporting.

58. The method of claim 55, wherein high priority devices are indicated by a parameter in a prioritization field of a broadcast message.

59. The method of claim 58, wherein the parameter comprises a 2-bit bitmap or the indication further comprises an identification of CSI settings for early CSI reporting.

60. The method of claim 55, further comprising:
sending a message from the node to the first device that is configured to override one or more CSI settings sent in a broadcast of system information.

61. The method of claim 55, wherein:
(i) the early CSI report is received from the first device in a MsgA of a 2-step random access procedure;
(ii) the early CSI report is received from the first device in a Msg3 of a 4-step random access procedure;
(iii) the early CSI report is received from the first device in a Msg3 of a fallback random access procedure;
(iv) the early CSI report is received from the first device in an acknowledgement feedback for successful reception of contention resolution in a 4-step random access procedure; or
(v) the early CSI report is received from the first device in an acknowledgement feedback for successful reception of RAR in a 2-step random access procedure.

62. A node, the node being configured to:
determine that a first device has a high priority status; and
send a message to the first device based at least in part on the status determination, wherein the message is configured to trigger channel state information, CSI, reporting from the first device before completion of a radio resource control, RRC, connection or as part of a random access procedure.

63. The node of claim 62, wherein determining that the first device has a high priority status is based at least in part on a preamble ID received from the first device or a physical random-access channel (PRACH) occasion on which a preamble was transmitted to the node from the first device.

64. The node of claim 62, wherein the message to the first device is a random access response (RAR) message.

65. The node of claim 62, wherein the node is further configured to:
receive an early CSI report from the first device, wherein the message to the first device is configured with a CSI request bit enabled.
